(19) United States
(12) Patent Application Publication
(10) Pub. No.: US 2020/0269997 A1
(43) Pub. Date: Aug. 27, 2020

(54) SINGLE-STAGE CRAFT AND METHOD FOR INTERPLANETARY SPACE TRAVEL

(71) Applicant: Jerome Drexler, Los Altos Hills, CA (US)

(72) Inventor: Jerome Drexler, Los Altos Hills, CA (US)

(21) Appl. No.: 16/283,416

(22) Filed: Feb. 22, 2019

(51) Int. Cl. B64G 1/40; B64G 1/00; B64G 1/10; B64G 1/24; B64G 99/00; B64G 1/42

(52) U.S. Cl. CPC B64G 1/408; B64G 1/007; B64G 1/10; B64G 2001/1064; B64G 9/00; B64G 1/42; B64G 1/242

(57) ABSTRACT

An interplanetary spacecraft makes use of ambient cosmic rays and muons generated therefrom to provide micro-fusion propulsion. The craft has a central reaction chamber surrounded by the craft's main body. Deuterium-containing fuel material is injected at a specified rate into the reaction chamber where it is exposed to the cosmic rays and muons to produce energetic reaction products. Some reaction products exit the chamber through an opening to provide reaction thrust, while other reaction products interact with a dome of the chamber to directly apply a thrusting force. The craft can be a preassembled station having multiple reaction chambers and can form an orbiting space station around a planet or moon or a manufacturing or habitat station on a planetary or lunar surface.

### TECHNICAL FIELD

The present invention relates to providing thrust, as well as artificial gravity, to interplanetary spacecraft with human occupants. The invention also relates to inducement or production of controlled nuclear fusion by particle-target and muon-catalyzed micro-fusion for thrust in the presence of ambient cosmic rays and muons.

### BACKGROUND ART

For space travel, whether between the Earth and the Moon or traveling among the planets (or any of its moons), it's often a good idea to minimize the propellant mass needed by your spacecraft and its launch vehicle. In a typical spaceflight scenario, a spacecraft will fire its rocket engines to accelerate in order to reach some planned velocity, and will then, when those rocket engines are shut off, continue under its own inertia with the same speed and trajectory it has attained.

In the prior art, three stage rockets have been used, along with liquid-hydrogen based fuels and liquid oxygen. These require very expensive launching facilities.

It is useful when traveling between planets in the solar system to consider that spacecraft as being in orbit around the Sun. The trajectory with minimal propellant usage is a transfer orbit in which the desired orbit's perihelion (closest approach to the Sun) will be at the distance of Earth's orbit and its aphelion (farthest distance from the sun) will be at the distance of Mars' orbit or of some other destination planet. (Likewise, for journeys to the inner planets of Mercury or Venus, the aphelion will coincide with Earth's orbit and the perihelion will coincide with the destination planet's orbit. It uses its rocket to accelerate opposite the direction of Earth's revolution around the sun, thereby decreasing its orbital energy.) Thus, in the typical scenario, most of the journey between the planets will then consist of coasting towards its destination with the engines turned off. Then to be captured into the destination planet's orbit, the spacecraft must then decelerate relative to that planet using a retrograde rocket burn or some other means.

In order to slow sufficiently to obtain orbital capture by the destination planet, the spacecraft must use about the same amount of fuel that it used to speed up originally. In general, if we want to reduce the travel time between Earth and Mars or some other planet, the more fuel we will need in order to accelerate the spacecraft to a higher coasting velocity and consequently the more fuel will need upon arrival to slow down in order to enter the planet's orbit and then to land. Maximum fuel usage occurs if one accelerates the spacecraft for fully one-half of the journey, with no coasting phase, and then decelerates over the remaining half of the journey. Present spacecraft systems use liquid fuels that constitute a very large percentage of the overall mass. If one could save fuel in some way, while still achieving the desired acceleration, coasting velocity and deceleration, one could shorten travel time or carry more passengers and/or cargo.

The typical accelerate-coast-decelerate scenario works well with unmanned probes. However, this will subject human astronauts to long periods of weightlessness during the coasting phase lasting 6 months or longer, depending on peak velocity. Additionally, long trip times will potentially expose astronauts to both solar and cosmic ray radiation. It is known from previous space missions, especially the experience developed from astronauts spending periods of time on space stations (Skylab, Salyut, Mir, and most recently the International Space Station), that weightlessness has adverse health effects upon humans. In the absence of gravity, astronauts lose muscle mass, the heart becomes deconditioned, and bones suffer osteoporosis, even when physical exercise is deliberately imposed as part of a strength maintenance regimen. Spaceflight designers have envisioned a number of ways to create an artificial gravity in space, basically constant acceleration of some form, the seemingly most straightforward of which is from the acceleration due to spacecraft thrust. However, this will require much more fuel than the typical accelerate-coast-decelerate scenarios for interplanetary travel.

Several projects have explored the possibility of nuclear spacecraft propulsion. The first of these was Project Orion from 1958-1963 built upon general proposals in the 1940s by Stanislaw Ulam and others, in which external atomic detonations would form the basis for a nuclear pulse drive. Later, between 1973 and 1978, Project Daedalus of the British Interplanetary Society considered a design using inertial confinement fusion triggered by electron beams directed against fuel pellets in a reaction chamber. From 1987 to 1988, Project Longshot by NASA in collaboration with the US Naval Academy developed a fusion engine concept also using inertial confinement fuel pellets but this time ignited using a number of lasers. Naturally, these last two projects depend upon successfully achieving nuclear fusion.

Muon-catalyzed fusion was observed by chance in late 1956 by Luis Alvarez and colleagues during evaluation of liquid-hydrogen bubble chamber images as part of accelerator-based particle decay studies. These were rare proton-deuteron fusion events that only occurred because of the natural presence of a tiny amount of deuterium (about one part per 6400) in the liquid hydrogen. It was quickly recognized that fusion many orders of magnitude larger would occur with either pure deuterium or a deuterium-tritium mixture. However, John D. Jackson (Lawrence Berkeley Laboratory and Prof. Emeritus of Physics, Univ. of California, Berkeley) correctly noted that for useful power production there would need to be an energetically cheap way of producing muons. The energy expense of generating muons artificially in particle accelerators combined with their short lifetimes has limited its viability as an Earth-based fusion source, since it falls short of break-even potential.

Another controlled fusion technique is particle-target fusion which comes from accelerating a particle to sufficient energy to overcome the Coulomb barrier and interact with target nuclei. To date, proposals in this area depend upon using some kind of particle accelerator. Although some fusion events can be observed with as little as 10 KeV acceleration, fusion cross-sections are sufficiently low that accelerator-based particle-target fusion are inefficient and fall short of break-even potential.

It is known that cosmic rays are abundant in interplanetary space. Cosmic rays are mainly high-energy protons (with some high-energy helium nuclei as well) with kinetic energies in excess of 300 MeV. Most cosmic rays have GeV energy levels, although some extremely energetic ones can exceed 10¹⁸ eV. FIG. 7 shows cosmic ray flux distribution at the Earth's surface after significant absorption by Earth's atmosphere. In near-Earth space, the alpha magnetic spectrometer (AMS-02) instrument aboard the International Space Station since 2011 has recorded an average of 45 million fast cosmic ray particles daily (approx. 500 per second within that instrument's effective acceptance area and measurement energy range). The overall flux of galactic cosmic ray protons (above Earth's atmosphere) can range from a minimum of 1200 m⁻²s⁻¹sr⁻¹ to as much as twice that amount. (The flux of galactic cosmic rays entering our solar system, while generally steady, has been observed to vary by a factor of about 2 over an 11-year cycle according to the magnetic strength of the heliosphere.) In regions that are outside of Earth's protective magnetic field (e.g. in interplanetary space), the cosmic ray flux has been estimated to be several orders of magnitude greater. As measured by the Martian Radiation Experiment (MARIE) aboard the Mars Odyssey spacecraft, average in-orbit cosmic ray doses were about 400-500 mSv per year, which is an order of magnitude higher than on Earth.

Cosmic rays are known to generate abundant muons from the decay of cosmic rays passing through Earth's atmosphere. Cosmic rays lose energy upon collisions with atmospheric dust, and to a lesser extent atoms or molecules, generating elementary particles, including pions and then muons, usually within a penetration distance of a few cm. Typically, hundreds of muons are generated per cosmic ray particle from successive collisions. Near sea level on Earth, the flux of muons generated by the cosmic rays' interaction by the atmosphere averages about 70 m⁻²s⁻¹sr⁻¹. The muon flux is even higher in the upper atmosphere. Measured muon flux levels on Earth reflect the fact that both Earth's atmosphere and geomagnetic field tend to deflect charged particles and shield our planet from cosmic radiation. The amount of shielding is somewhat lower, and thus the cosmic ray flux and muon generation are greater, at higher elevations and altitudes. Mars is a different story, having very little atmosphere (only 0.6% of Earth's pressure) and no magnetic field, so that muon generation at Mars' surface is expected to be very much higher than on Earth's surface.

In recent years, there have been proposals to send further spacecraft to Mars and then sending manned space vehicles to Mars. One such development project is by the private U.S. company SpaceX with aspirational plans for Mars flights with passengers by the mid-2020s. The United States has committed NASA to a long-term goal of human spaceflight and exploration beyond low-Earth orbit, including crewed missions toward eventually achieving the extension of human presence throughout the solar system and potential human habitation on another celestial body (e.g., the Moon, Mars).

It is generally expected to take about nine months to travel to Mars. To get to Mars in less time would require that one burn the rocket engines longer to achieve a higher coasting velocity, but this uses more fuel and isn't feasible with current rocket technology. Likewise, to provide a constant acceleration from thrust (one of the possible artificial gravity schemes) would require the rocket engines burn constantly over the entire flight, leading to even more fuel usage. Even using the standard accelerate-coast-decelerate trajectory, the spacecraft has an overall payload of 100 metric tons, calling for a significant weight penalty in fuel for its liquid rocket engines. Once Mars orbit is reached, the vehicle is too massive to rely upon parachutes and/or a “sky crane” tethered system to descend to the Martian surface. Supersonic retro-propulsion using thrust from large rocket engines are expected to do the job.

The advancing of propulsion technologies would improve the efficiency of trips to Mars and could shorten travel time to Mars, reduce consumables and mass of materials required for the journey, and reduce astronaut health risks from both weightlessness and radiation exposure. Sustained investments in early stage innovation and fundamental research in propulsion technologies is required to meet these goals.

This research and development activity is expected to proceed in several general stages, beginning with an Earth-reliant stage with research and testing on the ISS of concepts and systems that could enable deep space, long-duration crewed missions, followed by a proving ground stage in cis-lunar space to test and validate complex operations and components before moving on to largely Earth-independent stages. Such a proving ground stage would field one or more in-space propulsion systems capable of reaching Mars to undergo a series of shakedown tests to demonstrate their capabilities, select a final architecture, and make needed upgrades revealed by the shakedown tests. While systems already in development for the initial Earth-reliant missions largely make use of existing technologies, investment in the development of newer technologies will be needed to meet the longer-term deep space challenges.

### SUMMARY DISCLOSURE

A method of interplanetary space travel is provided for using a single-stage craft propelled in the presence of ambient cosmic rays. The spacecraft has a central reaction volume with at least an upper cover and a bottom opening and also has a main body surrounding the reaction volume. The main body includes a supply of deuterium-containing micro-fusion particle fuel material. Dispersing a quantity of the fuel material into the reaction volume at a specified rate through one or more ports in side walls of the reaction volume exposes the fuel material to an ambient flux of cosmic rays entering the reaction volume through the upper cover and to muons generated from the cosmic rays. The interactions of those cosmic rays and muons produce energetic reaction products, such as alpha particles. A downwardly directed portion of the reaction products is allowed to exit the reaction volume through the bottom opening to produce reaction thrust, while an upwardly directed portion of the reaction products is stopped by the upper cover to produce upward applied thrust upon the craft.

The upper cover may be a double-paned dome with muon generating material therebetween. Collisions of cosmic rays with the muon generating material supplies muons to the deuterium-containing particle fuel material to facilitate generation of energetic reaction products. The bottom opening of the reaction volume can include a deflection mechanism for selectively deflecting electrically charged reaction products escaping through the bottom opening to produce a specified direction of lateral motion. Alternatively, the side walls of the reaction volume might contain a set of radial output ports that selectively permit some energetic reaction products to escape in a specified lateral direction. The radial output ports could be selected using a moveable partial ring that covers all but a small number of selected radial output ports, or by opening and closing specified valves on such ports.

The reaction volume has a diameter selected such that thrust obtained exceeds gravitational force for a steady ground-based launch of the craft into orbit. For example, the craft might accelerate into successively higher orbits around a planet or moon of origination prior to insertion into an interplanetary trajectory, and likewise decelerate into successively lower orbits around a destination planet or moon prior to entry into a landing trajectory. The craft can be capable of round-trip travel between planets (or between a planet and moon).

Still further, the craft could be a preassembled station having at least one reaction volume, but preferably two or more reaction volumes, each coupled to a supply of deuterium-containing micro-fusion fuel particles and each having at least an upper cover and a bottom opening. The preassembled station could be a space station put into orbit around a planet or moon, or a manufacturing station transported to a surface of a planet or moon, or a habitat station providing crew quarters on a planetary or lunar surface.

The present invention of a new type of spacecraft does not have the problems associated with long periods of weightlessness. The present invention spacecraft is very versatile in its movement, thus providing utility. In a controlled manner, it can move vertically and laterally. It can arc around and between planets and moons and hover over or orbit each of them.

### BRIEF DESCRIPTION OF THE DRAWINGS

FIG. 1 is a schematic side view showing an embodiment of an interplanetary craft for operation in the presence of ambient cosmic rays and muons and having micro-fusion generated thrust for lift and propulsion.

FIG. 2 is a side sectional view showing of the internal reaction chamber of the craft in FIG. 1.

FIG. 3 is a side sectional view of an internal reaction chamber as in FIG. 2, but with a movable bottom opening for directional selection of escaping reaction products.

FIG. 4 is a side perspective view of a bottom opening of an internal reaction chamber as in FIG. 2, but having a deflection mechanism for escaping electrically-charged reaction products.

FIG. 5 is a schematic plan view of a plan for interplanetary travel with successive orbits of different size around source and destination planets or moons and an interplanetary trajectory therebetween.

FIG. 6 is a schematic top plan view of a craft in the form of a pre-assembled station with multiple reaction chambers for use either as an orbiting space station or as a manufacturing station or habitat station providing crew quarters situated on a planetary or lunar surface.

FIG. 7 is a graph of cosmic ray flux at the Earth surface versus cosmic ray energy, after very significant cosmic ray absorption by Earth's atmosphere and dust has occurred.

### DETAILED DESCRIPTION

The present invention provides micro-fusion powered craft for interplanetary travel, where the micro-fusion provides thrust for generating both lift from a planetary surface and lateral propulsion. The propulsion technology takes advantage of an abundance of ambient cosmic rays in space and muons generated from such cosmic rays to catalyze fusion events in enough amounts to produce useable thrust. The cosmic rays together with muons are available here for free and do not need to be generated artificially in an accelerator. The thrust also enables single-stage launch from (or landing upon) a lunar or planetary surface, including an ability to haul cargo and personnel up to some maximum weight that is dependent upon the amount of lift and propulsion provided by the micro-fusion. Since the amount of energy needed for thrust is generally much less than the multi-kiloton yields of atomic weapons, “micro-fusion” is the term used here to refer to fusion energy outputs of not more than 10 gigajoules per second (2.5 tons of TNT equivalent per second), to thereby exclude macro-fusion type explosions.

A craft is provided with a centrally located internal chamber with a dome on top and opening at the bottom. Deuterium-containing micro-fusion fuel material is inwardly injected at a specified rate into this chamber. Ambient cosmic rays and/or muons penetrate the dome from above and interact with the fuel material to generate energetic alpha particles and/or other reaction products that provide thrust to the craft. In particular, downwardly-directed alpha particles escape through the opening to produce a reaction thrust, while upwardly-directed alpha particles are stopped by the dome and produce applied thrust forces against the craft. Further, any fuel escaping through the bottom opening will also react externally with ambient cosmic rays and muons and the resulting reaction products will apply upward forces upon the underside of the craft. In interplanetary space, there is, of course, no “up” or “down” direction. But for convenience of discussion, the dome side of the craft will continue to be referred to as the “top” of the craft, while the side with the chamber opening will continue to be referred to as the “bottom” of the craft.

For lateral motion, the location of the opening at the bottom of the chamber might be moveable so that the selection of which generally downward-directed alpha particles escape and produce reaction thrust can vary. Still further, the bottom opening may have a deflection mechanism (e.g. based on electrostatic fields) that redirects or steers some or all the escaping alpha particles in a more lateral direction. The craft might also be provided with a set of external side ports for lateral motion. Deuterium-containing micro-fusion fuel material is ejected from one or more selected ports to form a cloud of fuel material outside the craft that interacts with the ambient cosmic rays and/or muons. Energetic micro-fusion reaction products interact with the side of the craft to provide lateral thrust moving the craft in a desired direction.

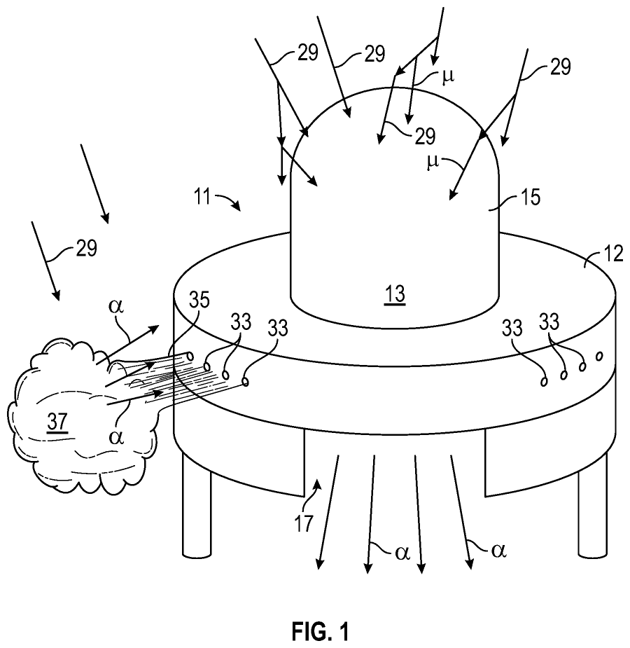

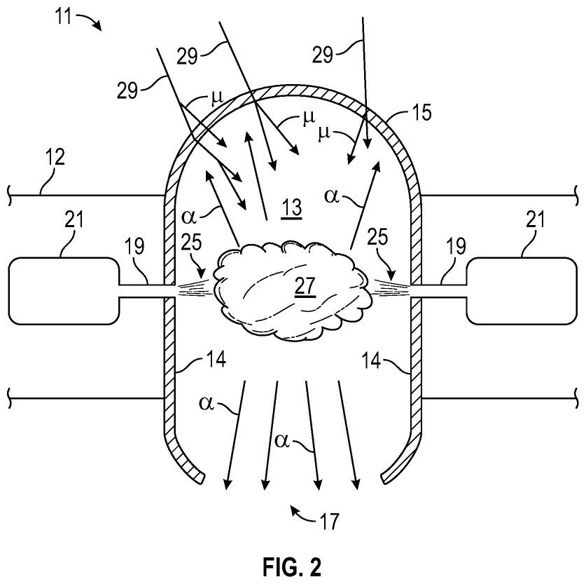

With reference to FIGS. 1 and 2, a craft 11 has a centrally located internal chamber 13 with a dome 15 on top and an opening 17 at the bottom. The craft 11 therefore constitutes a roughly disk-shaped, toroidal, tubular or doughnut-shaped main body portion 12 surrounding an internal chamber 13 which can extend somewhat above the top of the craft body by means of a bubble region with a dome 15 serving as a cover for the chamber 13. However, neither the central chamber 13 nor the main body portion 12 surrounding the central chamber 13 need be circular or radially symmetric, but could have an oval, elliptical, polygonal, or other odd shape. Cylindrical chambers and disc-shaped main bodies may be preferred for their compactness and economy of material, but other shapes are possible.

The dome 15 is effectively transparent to cosmic rays, with their extremely high energies (>100 Mev) and penetrating power, but essentially opaque to the substantially lower energy (˜10 MeV) alpha particle reaction products that will thus be stopped by the dome. It is expected that the dome material can be the same as the external skin 12 of the craft 11, but thinner. However, research and development efforts may optimize the choice of dome material and its thickness to achieve maximum cosmic ray penetration into the chamber 13, as well as to facilitate production of muons through interactions of those cosmic rays with the dome material. The dome 15 might even be double-paned structure with internal wire mesh, fibers and or even fine particulates to enhance muon creation. (Such a double-paned structure may also facilitate the provision of a cooling water or gas flow between the panes.) Such the presence of muon generators as a permanent structure of the dome 15 will lessen or even eliminate the need for having muon-generating particulate material within the fuel, thereby saving valuable fuel weight.

Additionally, the amount of curvature of the dome may be important to maximizing input of cosmic rays and muons into the chamber 13. The curvature of the “dome” may range from being completely flat to extending considerably upward above the top of the remainder of the craft 11, perhaps as much as twice as high as its radius. The much larger surface area of a large curvature dome 15 would facilitate cooling of the cover as it bombarded with ambient cosmic rays penetrating from outside and with micro-fusion reaction products (energetic alpha particles α) from within. A larger curvature might also allow relief of mechanical stresses from any heating that does result.

Except for fuel injection ports 19 leading into the chamber 13, the internal chamber is otherwise isolated from the rest of the craft 11 that radially surrounds it. Specifically, the sides 14 of the chamber 13, seen in FIG. 2, preferably provide sufficient radiation shielding to protect the craft's occupants and supplies, as well as stored fuel not yet injected into the chamber 13.

One or more fuel injection ports 19 are positioned in the sides 14 of the chamber 13 for ejecting micro-fusion fuel particles 25 from a stored supply 21 to create a cloud 27 of such material within the chamber 13. Ambient cosmic rays 29 and muons p generated from those cosmic rays penetrate the dome 15 and react with the cloud 27 of micro-fusion material to generate energetic fusion products, such as alpha particles α. At least some of these energetic fusion products are received by the craft 11 to provide upward thrust or lift. Specifically, some of the alpha particles α will be directed downward and escape through the opening 17 at the bottom of the chamber. These will provide an upward reaction thrust. Other alpha particles α will be directed upward and be stopped by the dome 15. These will produce an upward applied thrust force against the craft 11. Alpha particles α directed laterally in all directions will provide counteracting effects and negligible thrust contributions. Some of the deuterium-containing micro-fusion fuel material will also escape through the opening 17 in the bottom of the chamber 13. However, immediately outside the craft 11, such fuel will also interact with ambient cosmic rays and muons to generate micro-fusion reaction products (alpha particles α) at least some of which will be directed upward onto the underside of the craft 11. These will likewise apply an upward thrust force upon the craft 11. The combination of contributing upward forces will produce lift.

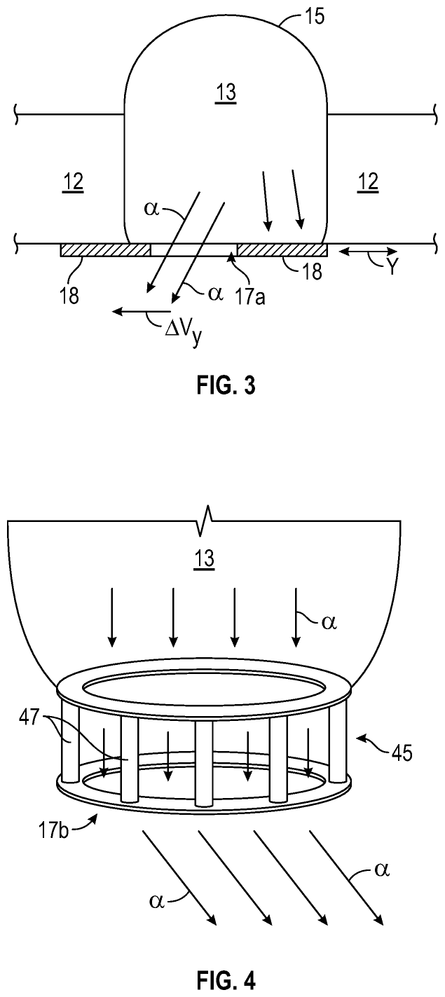

With reference to FIG. 3, a way to produce lateral thrust might be to have the bottom opening 17a in the chamber 13 be laterally moveable. For example, a plate 18 with the opening 17a therein might slide in a reciprocating (or even rotating) motion Y along the underside of the main craft body 12. Only certain alpha particles α traveling in a selected partially lateral trajectory can escape through the opening 17a, depending on its position, so that a preferential lateral thrust ΔVy is produced.

With reference to FIG. 4, in a further way of producing lateral thrust, because alpha particles have an electric charge, a deflection mechanism 45 at the bottom opening 17b of the chamber 13 can deflect or steer the alpha particles α and give them a lateral component of motion. For example, one mechanism for deflecting alpha particle exhaust can create an electric field using a set of tungsten rods 47, each having a different selected voltage. The voltage differential creates a lateral field that deflects alpha particles traversing the space between those rods 47. The alpha particles have a positive charge whose trajectory is influenced by the lateral electric field. The size and direction of that field can be varied by changing the voltages applied to the various rods 47, thereby varying the field. The amount of electricity required for deflection should be relatively small.

Returning to FIG. 1, the craft 11 may also have a set of side ports 33 located at various places around the craft. Selected side ports 33 eject micro-fusion particle material 35 to form a cloud 37 that likewise interacts with the ambient cosmic rays 29 and muons p to produce energetic micro-fusion products, such as alpha particles α, at least some of which are then received by that side of the craft 11 to provide lateral thrust in a desired direction. Selection of one or more side ports 33 change the direction of lateral movement. Also, if the craft can rotate, then fewer side ports 33 may be needed to achieve the same range of desired lateral movement.

Using any of these methods a pilot can vary the speed and direction of the craft 11 by varying the amount and direction of lateral thrust provided by the alpha particles.

In a similar manner, the craft 11 could further include a supplemental supply of deuterium-containing micro-fusion fuel particles that can be propelled externally below an underside of the craft (e.g. from ports like the side ports 33, but located instead on the underside of the craft) so as to interact with ambient cosmic rays and muons external to the craft to produce reaction products having kinetic energy. The additional upwardly directed portion of these reaction products will thus apply additional upward thrust upon the underside of the craft 11.

The fuel can be solid Li⁶D in powder form, D-D or D-T inertial-confinement-fusion-type pellets, or D₂O ice crystals, or even droplets of (initially liquid) D₂. Various types of micro-fusion reactions may also occur, such as Li⁶-D reactions, generally from direct cosmic ray collisions, as well as D-T, using tritium generated by cosmic rays impacting the lithium-6. D-T reactions especially may be assisted by muon-catalyzed fusion.

Muon-created muonic deuterium can come much closer to the nucleus of a similar neighboring atom with a probability of fusing deuterium nuclei, releasing energy. Once a muonic molecule is formed, fusion proceeds extremely rapidly (˜10-10 sec). One cosmic ray particle moving through the atmosphere and dust can generate hundreds of muons, and each muon can typically catalyze about 100 micro-fusion reactions before it decays (the exact number depending on the muon “sticking” cross-section to any helium fusion products).

Besides D-D micro-fusion reactions, other types of micro-fusion reactions may also occur (e.g. D-T, using tritium generated by cosmic rays impacting the lithium-6; as well as Li⁶-D reactions from direct cosmic ray collisions). In the reaction, Li⁶+D→2He⁴+22.4 MeV, much of the useful excess energy is carried as kinetic energy of the two helium nuclei (alpha particles). For this latter reaction, it should be noted that naturally occurring lithium can have an isotopic composition ranging anywhere from as little as 1.899% to about 7.794% Li⁶, with most samples falling around 7.4% to 7.6% Li⁶. Although LiD that has been made from natural lithium sources can be used in lower thrust applications or to inhibit a runaway macro-fusion event, fuel material that has been enriched with greater proportions of Li⁶ is preferable for achieving greater thrust and efficiency.

Additionally, any remaining cosmic rays after their travel through space can themselves directly stimulate micro-fusion events by particle-target fusion, wherein the high energy cosmic ray particles (mostly protons, but also helium nuclei) bombard relatively stationary target material. When bombarded directly with cosmic rays, the lithium-6 may be transmuted into tritium which could form the basis for some D-T micro-fusion reactions. Although D-D micro-fusion reactions occur at a rate only 1% of D-T micro-fusion, and produce only 20% of the energy by comparison, the freely available flux of cosmic rays and their generated muons should be sufficient to yield sufficient micro-fusion energy output for practical use.

The dispersed cloud of micro-fusion target material will be exposed to ambient cosmic rays and muons. To assist muon formation, the micro-fusion fuel material may contain up to 20% by weight of added particles of fine sand or dust. As cosmic rays collide with the micro-fusion material and dust, they form muons p that are captured by the deuterium and that catalyze fusion. Muon formation may also be facilitated by reaction of cosmic rays with the dome material. Likewise, the cosmic ray collisions themselves can directly trigger particle-target micro-fusion.

The amount of energy generated by the micro-fusion reactions, and the thrust the micro-fusion products produce, depends upon the quantity of fuel injected into the chamber 13 and the quantity of available cosmic rays and muons in the ambient environment that can enter the craft through the dome 15. Assuming much of the energy can be captured and made available for thrust, an estimated 10¹⁵ individual micro-fusion reactions (less than 1 μg of fuel consumed) per second would be required for 1 kW output. But as each cosmic ray can create hundreds of muons and each muon can catalyze about 100 reactions, the available cosmic ray flux in interplanetary space (believed to be several orders of magnitude greater than on Earth) is believed to be sufficient for this thrust purpose following research, development, and engineering efforts.

It is noted that as a craft is enlarged in its design, the potential energy output tends to scale as the square of the central reaction chamber's diameter, while the bulk of the craft's mass, located mainly in the disk main body surrounding the chamber, tends to scale only linearly according to the craft's circumference. As such, the craft may be scaled up to large enough dimensions to even become capable of single-stage launch from a planetary surface. Thrust need only exceed the force of gravity for that purpose.

The micro-fusion fuel material may be sprayed continuously as needed to sustain the fuel clouds both within the chamber 13 and externally adjacent to the craft 11. For the external side ports 33, the fuel can also be ejected in the form of projectiles. The projectiles would then chemically explode when they reach a desired distance from the craft 11 to disperse their micro-fusion particle fuel load and create the external fuel cloud. The amount of micro-fusion target material expended is quite small, since less than 1 μg of fuel material reacted per second would be required for 1 kW output. Exact amount of fuel needed will depend upon the ambient cosmic ray and muon flux and the reaction cross-sections for achieving the desired number (e.g. 10¹⁵) of reactions per second.

The volume of the continuous slow fusion creates high velocity fusion products (fast alpha particles or helium “wind”, etc.) that bombard the exterior of the craft. The energetic alpha particle micro-fusion products (a) provide thrust against the craft.

Stored fuel material 21 will be shielded within the craft 11 to reduce or eliminate premature micro-fusion events until delivered and dispersed as a fuel cloud within the interior chamber or outside the craft for thrusting. An inter-planetary astronaut crew will itself need shielding from radiation (which can cause brain damage and other adverse health effects). Therefore, the crew's shielding in the main body or disk section of the craft could double as a shield for the fuel material. One important source of such shielding will be the spacecraft's water supply, which should be adequate for the task. One need not completely eliminate cosmic rays or their secondary particles (pions, muons, etc.) to zero, but merely reduce their numbers and energies sufficiently to keep them from catalyzing sufficiently large numbers of fusion events in the stored target particle material. Additionally, since the use of micro-fusion fuel is expected to reduce the required amount of chemical rocket propellant by a factor of about two, one can easily afford the extra weight of some small amount of metal for shielding, if needed. (For example, the Juno spacecraft to Jupiter contains radiation vaults of 1 cm thick titanium to shield its electronics from external radiation. A similar type of vault might be used in this case for the shielding of the stored fuel.) After being shot from the spacecraft, the casing of the projectiles themselves will continue to provide some shielding until dispersal of the target particle material as a cloud.

A goal of the invention is to shorten the travel time to Mars or other planets and their moons (to reduce cumulative radiation doses to which the astronauts are subject) and likewise to provide a continuous acceleration or deceleration to offset or reduce weightlessness during the journey. Cosmic ray flux naturally present in interstellar space is used to power nuclear micro-fusion events (via particle-target micro-fusion and muon-catalyzed micro-fusion) that will propel the spacecraft, as well as generate electrical energy. Avoiding a weightless coasting phase of an interplanetary trajectory accomplishes the goal of both shorter travel times and providing an artificial “gravity” via the accelerating or decelerating thrust of the spacecraft.

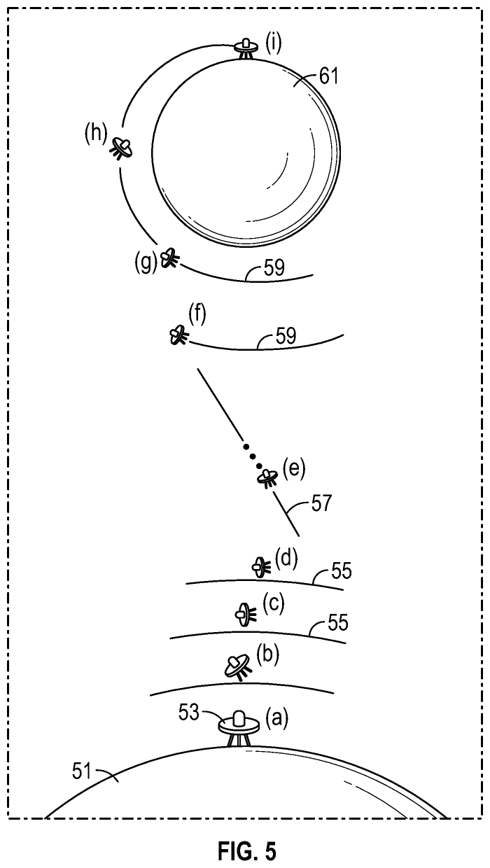

With reference to FIG. 5, a source planet 51 (e.g. Earth) is launch point (a) for a craft 53 constructed and operated in accord with the present invention. Since from recent measurements it is known that muon flux on Earth varies with altitude, it may be discovered after further research to preferably launch spacecraft 53 with this type of propulsion from airfields situated at higher altitudes (e.g. 1500 to 3000 meters). After launch, the craft may climb into a set (b), (c), (d) of ever-increasing orbits 55 about the planet 51 before insertion into an interplanetary or planetary-lunar trajectory 57. As seen at (e), the craft can continue to provide thrust during its travel along the trajectory 57. The craft enters a series of successively smaller orbits 59 around a destination 61 planet (e.g. Mars) or moon (e.g. Earth's own Moon, or Phobos or Deimos of Mars), as represented by (f), (g) and (h) until it lands at (i) upon the surface of its destination planet or moon 61. The craft can be oriented to provide thrust in the desired direction to either speed up or slow down as needed.

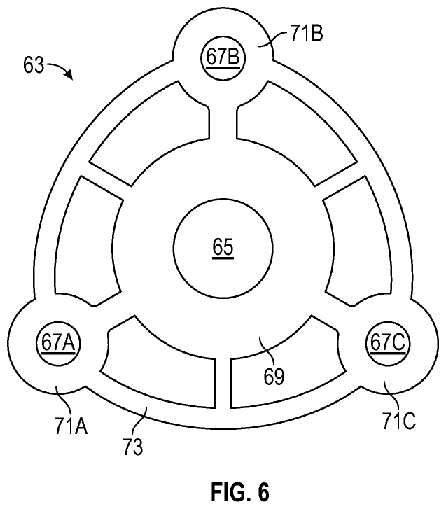

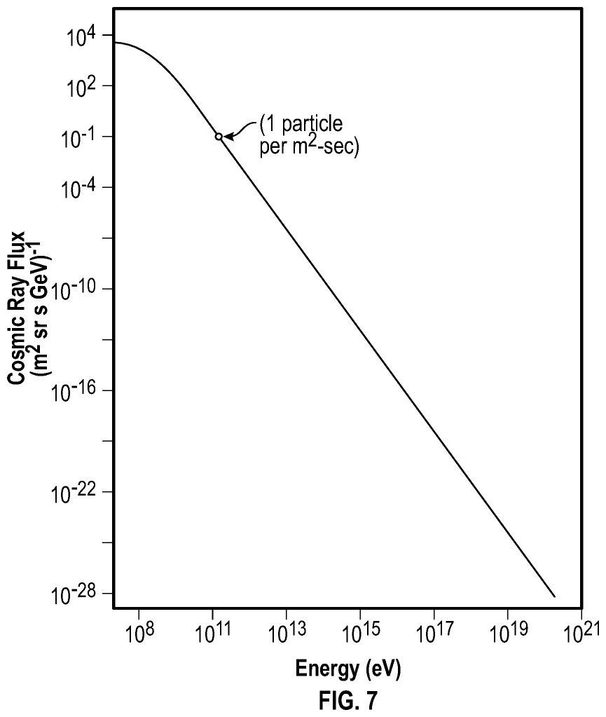

With reference to FIG. 6, a preassembled station 63 will have at least one central reaction chamber 65 surrounded by a main body 69. However, there may also be other reaction chambers, e.g. 67A, 67B, 67C, attached to the station 63. Multiple structural bodies, e.g. 71A, 71B, 71C, will surround the respective chambers 67A, 67, 67C. All of the bodies may be interconnected and structurally reinforced using various passageways 73. The interior of the bodies 69, 71A, 71B, 71C, etc. form crew quarters, working space, and equipment for operation of a space station, manufacturing station or habitat ground station. The station 63 can be launched and transported to a destination orbit or planetary/lunar surface using the micro-fusion generated propulsion from the reaction chambers. Because the amount of thrust can be controlled and sustained for long periods and, unlike chemical propulsion, not fully expended in short-term bursts of high impulse, a single-stage launch can be achieved as the craft slowly lifts itself into orbit, is transported to its destination planet or moon, and descends to a soft landing. A craft in the form of a space station, manufacturing ground station, or habitat station, can be designed and preassembled, then launched and landed intact upon the surface of a planet or moon. The reactor(s) can serve not only to provide steady propulsion, but also (at a lower level) provide electric power and heat for the habitat.

Because the technology is still early in a developmental phase, testing of its concepts might be perfected at some locations on Earth before its deployment in outer space, even though the ambient flux of cosmic rays and muons may be much lower due to Earth's geomagnetic field and thick atmosphere. Testing with craft at convenient higher altitude Earth locations would allow designers to improve the proposed micro-fusion engines before their use in traveling to and from the Moon, and then Mars. (Both cosmic ray flux and muon generation are known to substantially increase with altitude.) When used on Earth, some care will be needed when using some micro-fusion fuels. For example, lithium hydride (including Li⁶D) is known to be violently chemically reactive in the presence of water. While reactions with water are not a problem on the Moon or Mars, with any Earth applications the fuel material will need to be encapsulated to isolate it from water sources, including atmospheric vapor. A desiccant can also be used when storing the fuel material.

What is claimed is:

1. A method of interplanetary space travel using a single-stage craft propelled in the presence of ambient cosmic rays, the method comprising:
providing a spacecraft having a central reaction volume with at least an upper cover and a bottom opening and also having a main body surrounding the reaction volume, the main body having a supply of deuterium-containing micro-fusion particle fuel material;
dispersing a quantity of the fuel material into the reaction volume at a specified rate through one or more ports in side walls of the reaction volume, the fuel material interacting with an ambient flux of cosmic rays entering the reaction volume through the upper cover and with muons generated from the cosmic rays to produce reaction products having kinetic energy; and
allowing a downwardly directed portion of the reaction products to exit the reaction volume through the bottom opening to produce reaction thrust and stopping an upwardly directed portion of the reaction products by the upper cover to produce upward applied thrust upon the craft.

2. The method as in claim 1, wherein the upper cover is a double-paned dome with muon generating material therebetween, collisions of cosmic rays with the muon generating material supplying muons to the deuterium-containing particle fuel material to facilitate generation of energetic reaction products.

3. The method as in claim 1, wherein the bottom opening of the reaction volume includes a deflection mechanism for selectively deflecting electrically charged reaction products escaping through the bottom opening to produce a specified direction of lateral motion.

4. The method as in claim 1, wherein the side walls of the reaction volume contain a set of radial output ports that selectively permit some energetic reaction products to escape in a specified lateral direction.

5. The method as in claim 4, wherein radial output ports are selected using a moveable partial ring that covers all but a small number of selected radial output ports.

6. The method as in claim 4, wherein radial output ports are selected by opening and closing specified valves on such ports.

7. The method as in claim 1, wherein the reaction volume has a size selected such that thrust obtained exceeds gravitational force for a steady ground-based launch of the craft into orbit.

8. The method as in claim 1, wherein the craft further comprises a supplemental supply of deuterium-containing micro-fusion fuel particles coupled proximate to a bottom opening of the reaction volume, such that supplemental deuterium-containing fuel particles can be propelled externally below an underside of the craft so as to interact with ambient cosmic rays and muons external to the craft to produce reaction products having kinetic energy, an upwardly directed portion of the reaction products applying additional upward thrust upon the underside of the craft.

9. The method as in claim 1, wherein a craft accelerates into successively higher orbits around a planet or moon of origination prior to insertion into an interplanetary trajectory.

10. The method as in claim 1, wherein a craft decelerates into successively lower orbits around a destination planet or moon prior to entry into a landing trajectory.

11. The method as in claim 1, wherein the craft travels round-trip between source and destination planets.

12. A single-stage interplanetary space craft operable in the presence of ambient cosmic rays, comprising:
a central reaction volume with at least an upper cover and a bottom opening;
a main body surrounding the reaction volume, the main body having a supply of deuterium-containing micro-fusion fuel particles for injection into the central reaction volume via a set of one or more ports in side walls of the reaction volume;
wherein the fuel material, when dispersed within the central reaction volume, interacts with an ambient flux of cosmic rays entering the reaction volume through the upper cover and with muons generated from the cosmic rays to produce reaction products having kinetic energy, a downwardly directed portion of the reaction products exiting the reaction volume through the bottom opening to produce reaction thrust and an upwardly directed portion of the reaction products being stopped by the upper cover to produce upward applied thrust upon the craft.

13. The craft as in claim 12, wherein the side walls of the reaction volume contain a set of radial output ports that selectively permit some energetic reaction products to escape in a specified lateral direction.

14. The craft as in claim 13, wherein a moveable partial ring covers all but a small number of selected radial output ports.

15. The craft as in claim 13, wherein each radial output ports includes a corresponding selectively openable and closeable valve.

16. The craft as in claim 12, wherein the upper cover is a dome permitting cosmic rays and muons to penetrate while also blocking energetic reaction products generated within the reaction volume.

17. The craft as in claim 12, wherein the central reaction volume has a size selected such that thrust obtained exceeds gravitational force.

18. The craft as in claim 12, further comprising a supplemental supply of deuterium-containing micro-fusion fuel particles coupled proximate to a bottom opening of the reaction volume, such that supplemental deuterium-containing fuel particles can be propelled externally below an underside of the craft so as to interact with ambient cosmic rays and muons external to the craft to produce reaction products having kinetic energy, an upwardly directed portion of the reaction products applying additional upward thrust upon the underside of the craft.

19. The craft as in claim 12, comprising a preassembled space station having at least one reaction volume to put the space station into orbit around a planet or moon and to maintain that orbit.

20. The craft as in claim 19, wherein the space station has two or more reaction volumes, each reaction volume coupled to a supply of deuterium-containing micro-fusion fuel particles, each reaction volume having at least an upper cover and a bottom opening.

21. The craft as in claim 12, comprising a preassembled manufacturing station having at least one reaction volume to transport the manufacturing station to a surface of a planet or moon.

22. The craft as in claim 21, wherein the manufacturing station has two or more reaction volumes, each reaction volume coupled to a supply of deuterium-containing micro-fusion fuel particles, each reaction volume having at least an upper cover and a bottom opening.

23. The craft as in claim 12, comprising a preassembled habitat ground station that can be launched from and landed intact upon a surface of a planet or moon, the habitat station having at least one reaction volume coupled to a supply of deuterium-containing micro-fusion fuel particles, each reaction volume having at least an upper cover and a bottom opening, each reaction volume providing thrust for propulsion of the habitat station to its destination and also providing electric power and heat for the habitat.
